(19) United States
(12) Patent Application Publication
(10) Pub. No.: US 2021/0133686 A1
(43) Pub. Date: May 6, 2021

(54) TIME TRACKING DEVICE

(71) Applicant: Toni Theobald, Littleton, CO (US)

(72) Inventor: Toni Theobald, Littleton, CO (US)

(21) Appl. No.: 16/669,127

(22) Filed: Oct. 30, 2019

(51) Int. Cl. G06Q 10/10; G06Q 10/06; G07C 1/10; G06Q 40/00

(52) U.S. Cl. CPC G06Q 10/1091; G06Q 10/06398; G06Q 10/06395; G06Q 40/125; G06Q 10/063114; G07C 1/10

(57) ABSTRACT

A time tracking device to monitor employee productivity, including a main body, a plurality of mobile device compartments disposed on at least a portion of the main body to store at least one mobile device therein, at least one charging unit disposed within each of the plurality of mobile device compartments to connect to the at least one mobile device, and a time tracking unit disposed within at least a portion of the main body to increase a total number of hours worked in response to at least one of the plurality of mobile device compartments having the at least one mobile device stored therein and the at least one charging unit connected to the at least one mobile device.

### BACKGROUND

### 1. Field

The present general inventive concept relates generally to a device, and particularly, to a time tracking device.

### 2. Description of the Related Art

Many businesses rely on employee productivity to generate revenue. Specifically, the more an employee works, the more revenue a business will generate. As such, any time spent performing non-work related tasks causes a drop in production and a drop in revenue.

The modern time-clock system for businesses does not prohibit employees from using their phone on the job once checked-in. With an increase of casual use of cell phones in the office, businesses often lose employee production.

In addition, the cell phone can be a distraction to not only the employee using it, but also to fellow employees working around them.

Therefore, there is a need for a time tracking device that deters use of cell phones by employees during working hours.

There is also a need for a time tracking device that acts like a “time clock,” such that when a phone (i.e., mobile device) is connected thereto, an employee is “clocked in” automatically, and is “clocked out” automatically when the phone is disconnected therefrom.

### SUMMARY

The present general inventive concept provides a time tracking device, which may alternatively be known as a “time clock.”

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a time tracking device to monitor employee productivity, including a main body, a plurality of mobile device compartments disposed on at least a portion of the main body to store at least one mobile device therein, at least one charging unit disposed within each of the plurality of mobile device compartments to connect to the at least one mobile device, and a time tracking unit disposed within at least a portion of the main body to increase a total number of hours worked in response to at least one of the plurality of mobile device compartments having the at least one mobile device stored therein and the at least one charging unit connected to the at least one mobile device.

Each of the plurality of mobile device compartments may include a storage portion, and an access door hingedly disposed on at least a portion of the storage portion to cover the storage portion in a first position, and at least partially expose the storage portion in a second position.

The access door may include an input unit disposed on at least a portion of an outer surface of the access door to receive personalized information from a user, a display unit disposed on at least a portion of the outer surface of the access door to the time information thereon, and at least one indicator disposed on at least a portion of the access door to illuminate in response to the access door being locked in a first state, and to remain off in response to the access door being unlocked in a second state.

The at least one charging unit may be a charging cable.

The at least one charging unit may be a wireless induction surface.

The time tracking unit may maintain at least one of a connection time relating to when the at least one mobile device was connected within the at least one of the plurality of mobile device compartments, a duration of time since the connection time, a number of disconnects during work hours, and the total number of hours worked.

The time tracking device may further include at least one sanitizing unit disposed within at least a portion of each of the plurality of mobile device compartments to cleanse the at least one mobile device.

The time tracking device may further include a control unit disposed within at least a portion of the main body to monitor data from the time tracking unit to determine employee productivity based on the time information.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a front isometric view of a time tracking device, according to an exemplary embodiment of the present general inventive concept; and

FIG. 2 illustrates a rear isometric view of the time tracking device, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

List of Components

Time Tracking Device 100

Main Body 110

Rear Panel 111

Interior Portion 112

Mobile Device Compartments 120

Access Door 121

Input Unit 121a

Display Unit 121b

Window 121c

Indicators 121d

First Indicator 121d1

Second Indicator 121d2

Storage Portion 122

Rear Aperture 123

Charging Unit 130

Time Tracking Unit 140

Power Splitter 150

Power Line 151

Sanitizing Unit 160

Backup Battery 170

Control Unit 180

Power Source 190

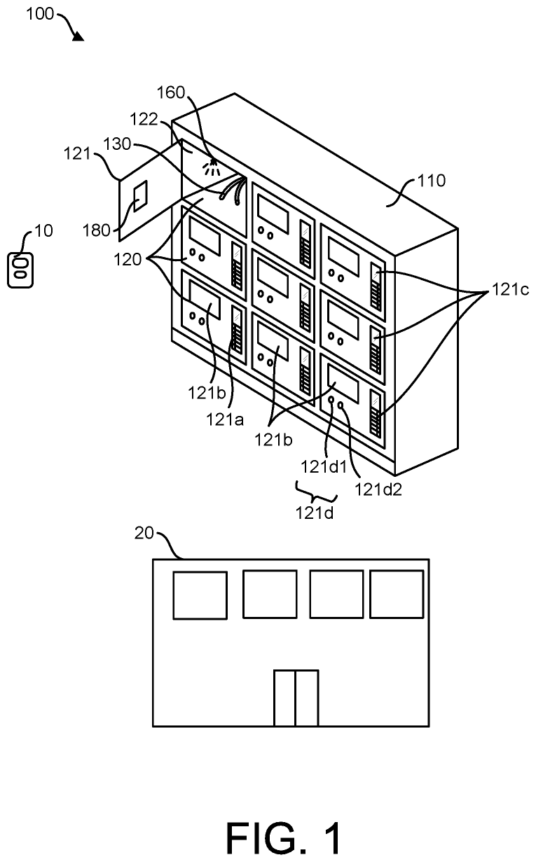

FIG. 1 illustrates a front isometric view of a time tracking device 100, according to an exemplary embodiment of the present general inventive concept.

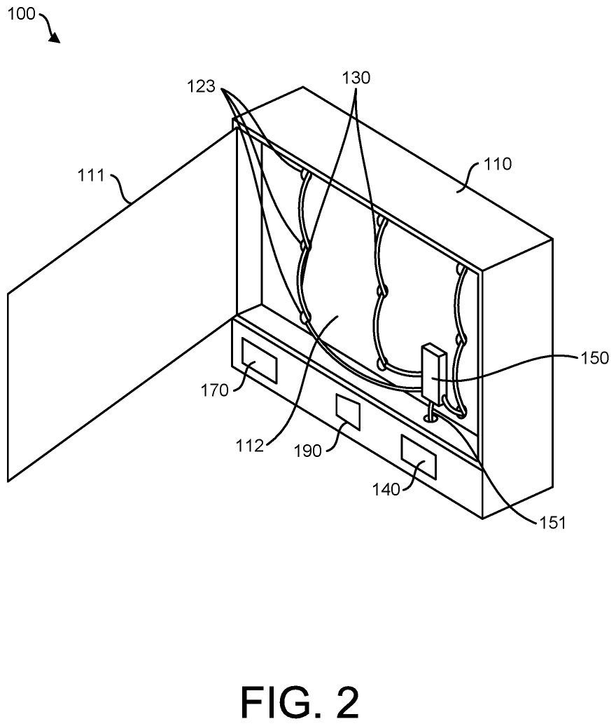

FIG. 2 illustrates a rear isometric view of the time tracking device 100, according to an exemplary embodiment of the present general inventive concept.

The time tracking device 100 may be constructed from at least one of metal, plastic, wood, ceramic, glass, and rubber, etc., but is not limited thereto.

The time tracking device 100 may include a main body 110, a plurality of mobile device compartments 120, at least one charging unit 130, a time tracking unit 140, a power splitter 150, at least one sanitizing unit 160, a backup battery 170, at least one control unit 180, and a power source 190, but is not limited thereto.

The time tracking device 100 may also be referred to as a “time clock,” and may function such that when a phone (i.e., mobile device) is connected thereto, an employee is “clocked in” automatically, and is “clocked out” automatically when the phone is disconnected therefrom.

Referring to FIGS. 1 and 2, the main body 110 is illustrated to have a rectangular prism shape. However, the main body 110 may be rectangular, circular, pentagonal, hexagonal, octagonal, or any other shape known to one of ordinary skill in the art, but is not limited thereto.

The main body 110 may include a rear panel 111 and an interior portion 112, but is not limited thereto.

The rear panel 111 may be removably disposed on at least a portion of a rear surface of the main body 110. The rear panel 111 may provide access to the interior portion 112 of the main body 112 in response to removal of the rear panel 111. In other words, the rear panel 111 may cover the interior portion 112 of the main body 110.

The rear panel 111 may restrict access therein to specific individuals, such as a manufacturer, an owner, and/or an administrator (collectively, authorized users). As such, the rear panel 111 may prevent tampering within the interior portion 112 by any unauthorized party.

Each of the plurality of mobile device compartments 120 may include an access door 121, a storage portion 122, and a rear aperture 123, but is not limited thereto.

The plurality of mobile device compartments 120 may be disposed on at least a portion of a front surface of the main body 110. Moreover, referring to FIG. 1, the plurality of mobile device compartments 120 is arranged in a three by three configuration. However, the plurality of mobile device compartments 120 may be arranged in any configuration as desired by the authorized user. For example, there may be only one compartment 120 or twenty compartments 120.

The access door 121 may be hingedly disposed on at least a portion of the storage portion 122 to cover the storage portion 122 in a first position, and at least partially expose the storage portion 122 in a second position. The access door 121 may cover the storage portion 122. The storage portion 122 may be disposed within a portion of the main body 110. Additionally, the storage portion 122 may store at least one mobile device 10 therein.

Referring to FIG. 2, the rear aperture 123 may be disposed at a rear of the storage portion 122, such that the rear aperture 123 may connect the storage portion 122 to the interior portion 112 of the main body 110.

The access door 121 may include an input unit 121a, a display unit 121b, a window 121c, and a plurality of indicators 121d, but is not limited thereto.

The input unit 121a may include an alphanumeric keypad, a card reader, a low frequency signal reader, and a biometric scanner, but is not limited thereto. As such, a user (i.e. an employee) seeking to store the at least one mobile device 10 within the storage portion 122 may input personalized information on the input unit 121a. For example, the user may input an alphanumeric code on the alphanumeric keypad, swipe a card on the card reader, move a key fob within proximity of the lower frequency signal reader, and/or provide a fingerprint, a voice, and/or a retinal scan on the biometric scanner. Any of the actions described above may be used to lock the access door 121, and subsequently repeated to unlock the access door 121. As such, the user may use any one of the plurality of mobile device compartments 120 to temporarily store the at least one mobile device 10 therein.

The display unit 121b may be disposed on at least a portion of the access door 121. The display unit 121b may display the personalized information based on the input relating to the user and/or the at least one mobile device 10. For example, the display unit 121b may display a name of the user and time information. The time information may include a connection time relating to when the at least one mobile device 10 was connected within the storage portion 122, a duration of time since the connection time, a number of disconnects during work hours, and/or a total number of hours worked.

The window 121c may be a first color (i.e. yellow). However, the window 121c may appear to change to a second color (i.e. green) in response to closing and locking the access door 121. More specifically, the window 121c may reflect a color of the storage portion 122 in response to closing and locking the access door 121.

Alternatively, the window 121c may be transparent while the access door 121 is open, and appear opaque in response to closing and locking the access door 121.

The plurality of indicators 121d may include a first indicator 121d1 and a second indicator 121d2, but is not limited thereto.

The plurality of indicators 121d may be disposed on at least a portion of the access door 121. The first indicator 121d1 and the second indicator 121d2 may each include a light. The first indicator 121d1 or the second indicator 121d2 may illuminate in response to the access door 121 being in a first state (i.e. locked). Additionally, the second indicator 121d2 or the first indicator 121d1 may illuminate in response to the access door 121 being in a second state (i.e. unlocked). As such, the second indicator 121d2 may not illuminate while the first indicator 121d1 is illuminated and vice versa.

Alternatively, the plurality of indicators 121d may be a single indicator 121d, such that the single indicator 121d may illuminate in response to the access door 121 being in the first state or the second state, and may remain off in response to the access door 121 being in the second state or the first state.

The at least one charging unit 130 may include at least one charging cable, but is not limited thereto. The at least one charging unit 130 may have a universal adapter disposed on the at least one charging cable to connect to the at least one mobile device 10. In other words, the at least one charging unit 130 may fit on any type of mobile device.

Alternatively, the at least one charging unit 130 may be a wireless induction surface, such that the at least one charging unit 130 may charge the at least one mobile device 10 wirelessly in response to receiving the at least one mobile device 10 thereupon.

Referring again to FIGS. 1 and 2, the at least one charging unit 130 may be at least partially disposed within at least a portion of the storage portion 122 via the rear aperture 123. As such, another portion of the at least one charging unit 130 may be disposed within the interior portion 112. The at least one charging unit 130 may provide power to the at least one mobile device 10, and provide the connection time to the display unit 121b in response to the at least one mobile device 10 being connected thereto.

Furthermore, subsequent to the access door 121b being locked and the at least one charging unit 130 being connected to the at least one mobile device 10, the display unit 121b may display the time information.

The time tracking unit 140 may include a clock and a chronometer, but is not limited thereto.

The time tracking unit 140 may be disposed on and/or within at least a portion of the main body 110. Moreover, the time tracking unit 140 may increase a total number of hours worked in response to at least one of the plurality of mobile device compartments 120 having the at least one mobile device 10 stored therein and the at least one charging unit 130 connected to the at least one mobile device 10. Furthermore, the time tracking unit 140 may maintain the time information.

Also, the time tracking unit 140 may maintain the time information to and/or from the plurality of mobile device compartments 120. Specifically, the time tracking unit 140 may track and transmit the time information to and/or from the input unit 121a and/or the display unit 121b.

Also, the time tracking unit 140 may include a door to prevent tampering therein by any unauthorized party. As such, only authorized users may access the time tracking unit 140 using a master key.

The power splitter 150 may include a power line 151, but is not limited thereto. Moreover, the power splitter 150 may include a plurality of resistors to divide power received from the power line 151.

The power splitter 150 may be connected to the at least one charging unit 130, such that power may be dispersed therethrough.

The at least one sanitizing unit 160 may include an ultraviolet (UV) light and a sanitizing liquid, but is not limited thereto.

The at least one sanitizing unit 160 may be disposed within at least a portion of the storage portion 122. The at least one sanitizing unit 160 may illuminate the UV light to sanitize the at least one mobile device 10 in response to closing and locking the access door 121, and while the at least one mobile device 10 is connected to the at least one charging unit 130. The UV light may cleanse (i.e. remove and/or kill any germs) the at least one mobile device 10.

Alternatively, the at least one sanitizing unit 160 may spray the sanitizing liquid to cleanse the at least one mobile device 10.

The backup battery 170 may include lithium-ion, nickel cadmium, nickel metal hydride, alkaline, etc., but is not limited thereto

The backup battery 170 may be disposed within at least a portion of the main body 110.

The control unit 180 may include a processing unit and a communications unit, but is not limited thereto.

The processing unit (or central processing unit, CPU) may include electronic circuitry to carry out instructions of a computer program by performing basic arithmetic, logical, control and input/output (I/O) operations specified by the instructions. The processing unit may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components. The processing unit may also include a microprocessor and a microcontroller.

The communication unit may include a device capable of wireless or wired communication between other wireless or wired devices via at least one of W-Fi, Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, Firewire, and Ethernet.

The control unit 180 may be disposed on and/or within at least a portion of the access door 121. The processing unit of the control unit 180 may receive the input from the input unit 121a to display the input information on the display unit 121b. Additionally, the communications unit of the control unit 180 may transmit the input information to the time tracking unit 140 and/or an employer 20, such as a payroll department for processing. More specifically, the control unit 180 may monitor data from the time tracking unit 140 to determine employee productivity based on the time information.

The power source 190 may include a power inlet and a solar cell, but is not limited thereto.

The power source 190 may receive power from an external power source, such as an electrical socket and/or receiving energy on the solar cell from an external light source.

The backup battery 170 may supply power to the time tracking device 100 in the event of power failure, such that the power source 190 does not receive the external power source.

The backup battery 170 may send power to the time tracking device 100 in response to the power failure. Conversely, the backup battery 170 may stop sending power to the time tracking device 100 in response to the power source 190 receiving the external power source. Moreover, the power source 190 may charge the backup battery 170 in response to receiving the external power source.

Additionally, the power splitter 150 may divide the power to distribute power evenly to the plurality of mobile device compartments 120, the at least one charging unit 130, the time tracking unit 140, the at least one sanitizing unit 160, the backup battery 170, and the control unit 180.

Therefore, the time tracking device 100 may monitor the time during which the at least one mobile device 10 is within the plurality of mobile device compartments 120, such that an employer may track employee productivity. Furthermore, the time tracking device 100 may deter the employee from using the at least one mobile device 10 during working hours.

The present general inventive concept may include a time tracking device 100 to monitor employee productivity, including a main body 110, a plurality of mobile device compartments 120 disposed on at least a portion of the main body 110 to store at least one mobile device 10 therein, at least one charging unit 130 disposed within each of the plurality of mobile device compartments 120 to connect to the at least one mobile device 10, and a time tracking unit 140 disposed within at least a portion of the main body 110 to increase a total number of hours worked in response to at least one of the plurality of mobile device compartments 120 having the at least one mobile device 10 stored therein and the at least one charging unit 130 connected to the at least one mobile device 10.

Each of the plurality of mobile device compartments 120 may include a storage portion 122, and an access door 121 hingedly disposed on at least a portion of the storage portion 122 to cover the storage portion 122 in a first position, and at least partially expose the storage portion 122 in a second position.

The access door 121 may include an input unit 121a disposed on at least a portion of an outer surface of the access door 121 to receive personalized information from a user, a display unit 121b disposed on at least a portion of the outer surface of the access door 121 to the time information thereon, and at least one indicator 121d disposed on at least a portion of the access door 121 to illuminate in response to the access door 121 being locked in a first state, and to remain off in response to the access door 121 being unlocked in a second state.

The at least one charging unit 130 may be a charging cable.

The at least one charging unit 130 may be a wireless induction surface.

The time tracking unit 140 may maintain at least one of a connection time relating to when the at least one mobile device 10 was connected within the at least one of the plurality of mobile device compartments 120, a duration of time since the connection time, a number of disconnects during work hours, and the total number of hours worked.

The time tracking device 140 may further include at least one sanitizing unit 160 disposed within at least a portion of each of the plurality of mobile device compartments 120 to cleanse the at least one mobile device 10.

The time tracking device 140 may further include a control unit 180 disposed within at least a portion of the main body 110 to monitor data from the time tracking unit 140 to determine employee productivity based on the time information.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A time tracking device to monitor employee productivity, comprising:
a main body;
a plurality of mobile device compartments disposed on at least a portion of the main body to store at least one mobile device therein;
at least one charging unit disposed within each of the plurality of mobile device compartments to connect to the at least one mobile device; and
a time tracking unit disposed within at least a portion of the main body to increase a total number of hours worked in response to at least one of the plurality of mobile device compartments having the at least one mobile device stored therein and the at least one charging unit connected to the at least one mobile device.

2. The time tracking device of claim 1, wherein each of the plurality of mobile device compartments comprises:
a storage portion; and
an access door hingedly disposed on at least a portion of the storage portion to cover the storage portion in a first position, and at least partially expose the storage portion in a second position.

3. The time tracking device of claim 2, wherein the access door comprises:
an input unit disposed on at least a portion of an outer surface of the access door to receive personalized information from a user;
a display unit disposed on at least a portion of the outer surface of the access door to the time information thereon; and
at least one indicator disposed on at least a portion of the access door to illuminate in response to the access door being locked in a first state, and to remain off in response to the access door being unlocked in a second state.

4. The time tracking device of claim 1, wherein the at least one charging unit is a charging cable.

5. The time tracking device of claim 1, wherein the at least one charging unit is a wireless induction surface.

6. The time tracking device of claim 1, wherein the time tracking unit maintains at least one of a connection time relating to when the at least one mobile device was connected within the at least one of the plurality of mobile device compartments, a duration of time since the connection time, a number of disconnects during work hours, and the total number of hours worked.

7. The time tracking device of claim 1, further comprises:
at least one sanitizing unit disposed within at least a portion of each of the plurality of mobile device compartments to cleanse the at least one mobile device.

8. The time tracking device of claim 1, further comprises:
a control unit disposed within at least a portion of the main body to monitor data from the time tracking unit to determine employee productivity based on the time information.
